(19) United States
(12) Patent Application Publication
(10) Pub. No.: US 2007/0104109 A1
(43) Pub. Date: May 10, 2007

(54) Method and apparatus for RLC protocol error handling in a wireless communications system

(75) Inventor: Sam Shiaw-Shiang Jiang, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited

(21) Appl. No.: 11/591,490

(22) Filed: Nov. 2, 2006

Related U.S. Application Data
(60) Provisional application No. 60/597,017, filed on Nov. 4, 2005.

(51) Int. Cl. H04J 1/16; H04B 7/216

(52) U.S. Cl. 370/244; 370/335; 370/342

(57) ABSTRACT

A method for radio link control error handling procedure in a wireless communications system including a first communication device and a second communication device includes a first radio link control entity of the first communication device only resetting a transmitting side of the first radio link control entity when a protocol error of the transmitting side is detected.

### CROSS REFERENCE TO RELATED APPLICATIONS

This application claims the benefit of U.S. Provisional Application No. 60/597,017, filed on Nov. 4, 2005 and entitled “Method and Apparatus for Single-Sided RLC Reset Procedure,” the contents of which are incorporated herein by reference.

### BACKGROUND OF THE INVENTION

1. Field of the Invention

The present invention relates to methods of handling protocol errors in a wireless communications system, and more particularly, to a method of resetting a single side of an RLC entity in the wireless communications system.

2. Description of the Prior Art

The third generation (3G) mobile communications system has adopted a Wideband Code Division Multiple Access (WCDMA) wireless air interface access method for a cellular network. WCDMA can provide high frequency spectrum utilization, universal coverage, and high quality, high speed multimedia data transmission. The WCDMA method also meets all kinds of QoS requirements simultaneously, providing diverse flexible two-way transmission services and better communication quality to reduce transmission interruption rates.

Taking a wireless communications protocol standard set forth by the 3rd Generation Partnership Project (3GPP) as an example, the 3G mobile communications system can provide different levels of transmission quality, and can operate in different modes based on different transmission quality requirements, e.g. Transparent Mode (TM), Unacknowledged Mode (UM), and Acknowledged Mode (AM). TM is appropriate for use in services with high requirements for real-time transmission, UM is appropriate for use in services with requirements for real-time transmission and packet sequencing, and AM is appropriate for use in services with low requirements for real-time transmission, but high requirements for data accuracy.

In order to ensure the accuracy of data, in AM, the RLC entity can execute a reset procedure to recover a protocol error so as to avoid a permanent failure in transmission of the data. According to a communications protocol specification (3GPP TS 25.322 V6.4.0 (2005-06), “Radio Link Control (RLC) protocol specification (Release 6)”) established by the 3GPP, when the RLC entity of a transmitter detects three conditions, the reset procedure is executed. In order to describe the three conditions clearly, the following is a description of variables and parameters, and a mode of operation for deleting Service Data Units (SDU).

Variable VT(DAT): Indicates a number of times an AM PDU has been scheduled for transmission. Every PDU corresponds to a VT(DAT), and VT(DAT) uses accumulation to compile statistics on the number of times the corresponding PDU has been scheduled for transmission.

Variable VT(MRW): Indicates a number of times a Move Receiving Window (MRW) command has been transmitted.

Parameter MaxDAT: Indicates an upper limit of VT(DAT). The number of times the AM PDU can be scheduled for transmission must be less than MaxDAT. When VT(DAT) equals MaxDAT, the RLC entity executes the reset procedure or a SDU discard procedure.

Parameter MaxMRW: Indicates an upper limit of VT(MRW). The number of times the MRW command can be transmitted must be less than MaxMRW.

Four operation modes are used to discard SDUs, three of which are related to AM:

1. Timer-based discard with explicit signaling: This mode uses a timer Timer_Discard corresponding to an SDU to count. When the timer Timer_Discard expires, the SDU is discarded. In addition, if the “Send MRW” is configured, or if one or many segments of the SDU have already been transmitted to a receiver, explicit signaling is used to notify the receiver.

2. SDU discard after MaxDAT number of transmissions: In this mode, if the number of times a PDU is scheduled for transmission, i.e. VT(DAT), reaches the parameter MaxDAT, the transmitter will discard all SDUs that have segments or “Length Indicators” indicating the end of the SDUs in the PDU, and explicit signaling is used to notify the receiver.

3. No discard after MaxDAT number of transmissions: In this mode, if the number of times a PDU is scheduled for transmission, i.e. VT(DAT), reaches the parameter MaxDAT, the transmitter will execute the RLC reset procedure.

When a protocol error is detected, the RLC reset procedure is initiated, and a principle for determining the protocol error is according to whether the RLC entity of the transmitter detects one of the three following conditions:

Condition 1: “No discard after MaxDAT number of transmissions” mode is configured, and the variable VT(DAT) is equal to the parameter MaxDAT, and then the RLC reset procedure will be executed.

Condition 2: The variable VT(MRW) is equal to the parameter MaxMRW.

Condition 3: A STATUS PDU or a piggybacked STATUS PDU reported by the receiver to the transmitter contains an erroneous sequence number, such as a sequence number reported as missing that has already been acknowledged as received, or a sequence number reported as received that has not yet been transmitted by the transmitter.

Thus, the three conditions of the reset procedure described above all occur at the transmitter of the RLC entity, i.e. an uplink for a mobile phone (user end) and a downlink for a networking device (network end).

After the reset procedure has been initiated, the reset procedure will stop data transfer, exchange a hyper frame number (HFN) of the uplink and the downlink to ensure that HFNs used in the transmitter and the receiver are synchronized to each other, delete PDUs that the receiving side of the RLC entity has received but has not yet delivered to the upper layer, delete SDUs already transmitted by the transmitting side of the RLC entity, reset state variables, and finally, restart data transfer. Thus, the reset procedure not only consumes time, but also causes data deletion, thereby reducing transmission efficiency.

The following description takes the user end initiating the reset procedure as an example. Of course, the following description is also true conversely when the network end initiates the RLC reset procedure.

When the user end detects any of the three RLC reset initiating conditions mentioned above, this indicates that a protocol error occurred in the uplink. In theory, only the uplink need be reset. However, in the prior art, before the reset procedure has finished, data reception in the downlink is also stopped, even if the data transmission in the downlink is operating normally. In other words, after the protocol error occurs in the uplink and the reset procedure is initiated, no matter if the downlink is operating normally or not, the prior art will stop the data reception of the downlink. Further, according to the prior art, PDUs in a receiving buffer of the downlink stored before the reset procedure is initiated must be deleted. If the deleted PDUs are to be retransmitted by the network end after the reset procedure is completed, this will reduce the transmission efficiency of the downlink. Likewise, if SDUs carried by the deleted PDUs are deleted during the reset procedure, the SDUs of the downlink will be unnecessarily deleted.

According to the communications protocol standard mentioned above, when the peer RLC entity (in this example, the RLC entity of the network end) successfully receives a RESET PDU used to initiate the RLC reset procedure, the peer RLC entity will respond with a RESET ACK PDU, reset its state variables and sequence number, discard relevant PDUs and begin transmitting PDUs. If the RESET ACK PDU is lost in the wireless transmission process, the RLC entity of the user end will retransmit another RESET PDU. In this situation, because the RLC entity of the user end stops receiving any PDUs before the reset procedure concludes, the PDUs transmitted between the network end responding with the first RESET ACK PDU and receiving the second RESET PDU are wasted.

In other words, because the reset procedure of the prior art simultaneously resets the uplink and the downlink of the RLC layer, data is unnecessarily deleted, affecting transmission efficiency, and wasting system resources.

### SUMMARY OF THE INVENTION

According to the present invention, a method of handling protocol errors is used in a wireless communications system comprising a first communications apparatus and a second communications apparatus that have established a wireless connection. The method comprises a first Radio Link Control (RLC) entity of the first communications apparatus resetting only a transmitting side of the first RLC entity when a protocol error of the transmitting side is detected.

According to the present invention, a first mobile communications device of a wireless communications system is utilized for handling protocol errors and has a wireless connection established with a second mobile communications device. The first mobile communications device comprises a control circuit for realizing a function of the first mobile communications device, a central processing unit for executing a program code to operate the control circuit, and a memory for storing the program code. The program code comprises a first Radio Link Control (RLC) entity only resetting a transmitting side of the first RLC entity when a protocol error of the transmitting side is detected.

According to the present invention, a method of handling protocol errors in a wireless communications system comprises an Radio Link Control (RLC) entity transmitting at least one control Protocol Data Unit (PDU) corresponding to a receiving side of the RLC entity when the RLC entity executes a reset procedure.

According to the present invention, a mobile communications device used in a wireless communications system is utilized for handling a protocol error. The mobile communications device comprises a control circuit for realizing a function of the mobile communications device, a central processing unit for executing a program code to operate the control circuit, and a memory for storing the program code. The program code comprises an Radio Link Control (RLC) entity transmitting at least one control Protocol Data Unit (PDU) corresponding to a receiving side of the RLC entity when a reset procedure of the RLC entity is executed

According to the present invention, a method of handling protocol errors in a wireless communications system comprises an Radio Link Control (RLC) entity only resetting a receiving side of the RLC entity when the RLC entity receives a RESET Protocol Data Unit (PDU).

According to the present invention, a mobile communications device used in a wireless communications system is utilized for handling a protocol error. The mobile communications device comprises a control circuit for realizing a function of the mobile communications device, a central processing unit for executing a program code to operate the control circuit, and a memory for storing the program code. The program code comprises an Radio Link Control (RLC) entity only resetting a receiving side of the RLC entity when the RLC entity receives a RESET Protocol Data Unit (PDU).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communications device according to the present invention.

FIG. 2 is a diagram of program code of FIG. 1.

FIGS. 3-5 are flow chart diagrams of embodiments of the present invention method.

### DETAILED DESCRIPTION

In the communications protocol specification (3GPP TS 25.322 V6.4.0 (2005-06), “Radio Link Control (RLC) protocol specification (Release 6)”) established by the 3GPP, parameters, variables, timers, and control PDUs, etc. are defined according to different operating requirements. Based on the above-mentioned communications protocol specification, the parameters, variables, and timers can be defined as corresponding to the transmitting side or the receiving side of the RLC layer. Taking status variables for AM as an example, status variables corresponding to status of the receiving side comprise VR(R), VR(H), and VR(MR). Status variables corresponding to status of the transmitting side comprise VT(S), VT(A), VT(DAT), VT(MS), VT(PDU), VT(SDU), VT(RST), VT(MRW), and VT(WS). Timers corresponding to the receiving side comprise Timer_Status_Periodic and Timer_Status_Prohibit. Timers corresponding to the transmitting side comprise Timer_Poll, Timer_Poll_Periodic, Timer_Poll_Prohibit, Timer_Discard, Timer_RST, and Timer_MRT. Protocol parameters corresponding to the receiving side comprise Configured_Tx_Window_Size. Protocol parameters corresponding to the transmitting side comprise MaxDAT, Poll_PDU, Poll_SDU, Poll_Window, MaxRST, MaxMRW, and Configured_Rx_Window_Size. OSD_Window_Size and DAR_Window_Size are for UM and thus not considered in this specification. Definitions for the above-mentioned status variables, timers, and protocol variables can be found in the communications protocol specification, and are not repeated here.

However, regarding control PDUS, the above-mentioned communications protocol specification does not clearly define which control PDUs correspond to the receiving side of the RLC layer, and which control PDUs correspond to the transmitting side of the RLC layer. In order to clearly describe the spirit of the present invention, the following is a definition of which side each control PDU corresponds to. First, the above-mentioned communications protocol specification separates the control PDUs into three broad categories: 1) STATUS PDUs and Piggybacked STATUS PDUs, 2) RESET PDUs, and 3) RESET ACK PDUs. The first type of control PDU is primarily comprised of a header (for indicating the type of PDU), one or a plurality of super fields (SUFI), and a PAD. By setting information carried by the SUFIs, the STATUS PDU can become one of the following types:

1. ACK/NACK: A receiving status report which the receiver reports back to the transmitter regarding information about received or lost PDUs.

2. Change Window Size: Information transmitted to the transmitter by the receiver requesting the transmitter to change the size of the transmission window.

3. MRW (Move Receiving Window): A request to the receiver by the transmitter to advance a position of the receiving window of the receiver.

4. MRW ACK: Report sent from the receiver to the transmitter to acknowledge that the receiver has already received a STATUS PDU comprising an MRW.

On the other hand, the RESET PDU is transmitted to the receiver from the transmitter, and used to achieve HFN synchronization by using exchanged HFN values, resetting all of the protocol parameters, status variables, and timers. Analogously, the RESET ACK PDU is a report sent by the receiver to the transmitter to acknowledge receipt of the RESET PDU.

The ACK/NACK, Change Window Size, and MRW ACK STATUS PDUs and the RESET ACK PDU all correspond to the receiving side of the RLC entity. The MRW STATUS PDU and the RESET PDU correspond to the transmitting side of the RLC entity.

Having clearly defined which control PDUs correspond to which side of the RLC entity, we can now move on to describe the embodiments of the present invention.

The present invention relates to a wireless communications system operating in Acknowledged Mode, and is utilized to reset a single side of the RLC entity to handle protocol errors to increase transmission efficiency and prevent waste of system resources. The wireless communications system is preferably a 3G mobile communications system.

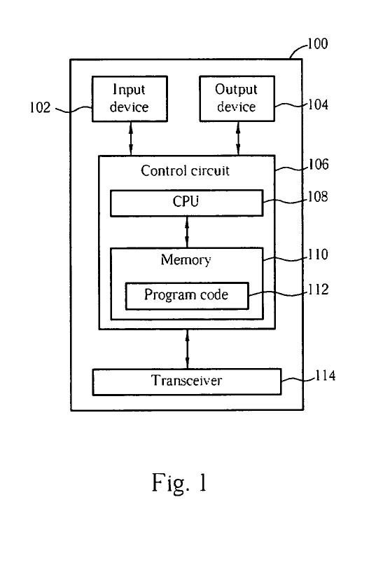

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

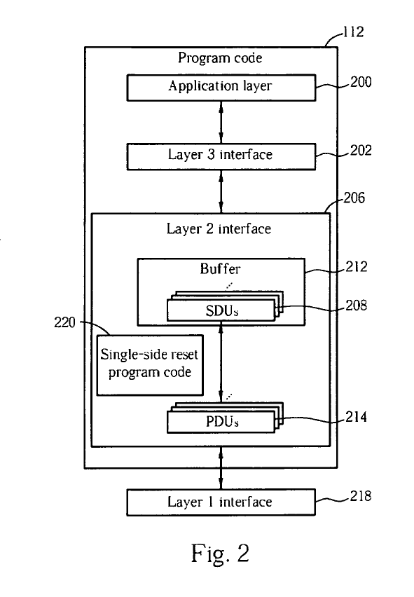

Please continue to refer to FIG. 2. FIG. 2 is a diagram of the program code 112 shown in FIG. 1. The program code 112 comprises an application layer 200, a Layer 3 interface 202, and a Layer 2 interface 206, and is coupled to a Layer 1 interface 218. When a signal is transmitted, the Layer 2 interface 206 forms a plurality of SDUs 208 according to data submitted by the Layer 3 interface 202, and stores the plurality of SDUs 208 in a buffer 212. Then, based on the SDUs 208 stored in the buffer 212, the Layer 2 interface 206 generates a plurality of PDUs 214, and sends the plurality of PDUs 214 to a destination terminal through the Layer 1 interface 218. In contrast, when a wireless signal is received, the signal is received through the Layer 1 interface 218, then delivered as PDUs 214 to the Layer 2 interface 206. The Layer 2 interface 206 restores the PDUs 214 to SDUs 208 and stores the SDUs 208 in the buffer 212. Last, the Layer 2 interface 206 delivers the SDUs 208 stored in the buffer 212 to the Layer 3 interface 202.

When the communications device 100 operates in AM, if the RLC entity, i.e. the Layer 2 interface 206, detects a protocol error, the reset procedure can be executed to recover the protocol error so as to avoid permanent data transmission failure. The present invention can reset the RLC entity in one side according to a single-side reset procedure program code 220, thereby increasing transmission efficiency and preventing waste of system resources.

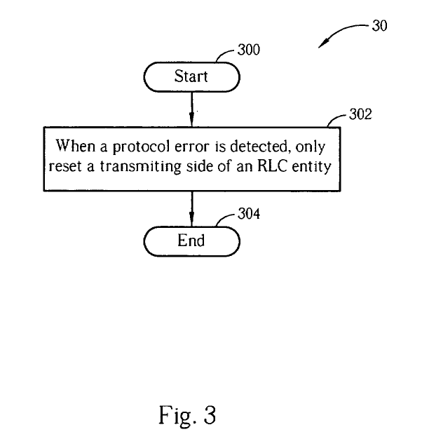

Please refer to FIG. 3, which is a diagram of a process 30 according to the present invention. The process 30 is used in a wireless communications system for handling protocol errors by resetting a single side of an RLC layer, and can be seen as the single-side reset procedure program code 220. The process 30 comprises the following steps:

Step 300: Start.

Step 302: When a protocol error is detected, only reset a transmitting side of an RLC entity.

Step 304: End.

Thus, according to the process 30, when the present invention detects the protocol error, only the transmitting side of the RLC entity is reset, without changing or affecting the operation of the receiving side of the RLC entity. The following three conditions can be used to determine if a protocol error has occurred:

Condition 1: “No discard after MaxDAT number of transmissions” mode is configured, and the variable VT(DAT) is equal to the parameter MaxDAT, and then the RLC layer reset procedure will be executed.

Condition 2: The variable VT(MRW) is equal to the parameter MaxMRW.

Condition 3: A STATUS PDU or a piggybacked STATUS PDU reported by the receiver to the transmitter contains an erroneous sequence number, such as a sequence number reported as missing that has already been acknowledged as received, or a sequence number reported as received that has not yet been transmitted by the transmitter.

All three conditions mentioned above for executing the reset procedure occur in the transmitting side of the RLC entity, i.e. the uplink for the user end (e.g. a mobile phone) and the downlink for the network end (e.g. a network terminal). When the RLC entity detects one of the three conditions mentioned above, the present invention can only reset the transmitting side of the RLC entity. After only starting resetting the transmitting side of the RLC entity, the RLC entity can preferably transmit a RESET PDU comprising a Hyper Frame Number Indicator (HFNI) field to an RLC entity of a target end to indicate a current hyper frame number of the transmitter of the RLC entity. Further, the RLC entity will stop transmitting PDUs and delete control PDUs corresponding to the transmitting side, such as an MRW STATUS PDU. In addition, after only starting resetting the transmitting side of the RLC entity, the present invention does not stop a reset timer Timer_RST, a periodic polling timer Timer_Poll_Periodic, an SDU discard timer Timer_Discard, and a plurality of timers corresponding to the receiving side of the RLC entity, e.g. a status prohibiting timer Timer_Status_Prohibit and a periodic status timer Timer_Status_Periodic. Preferably, the present invention can stop a plurality of timers corresponding to the transmitting side, e.g. a polling timer Timer_Poll, a poll prohibiting timer Timer_Poll_Prohibit, and an MRW timer Timer_MRW. As for the discard timer Timer_discard, it is not stopped if the corresponding SDU is not discarded during the RESET procedure.

In other words, when the protocol error on the transmitting side is detected, the present invention only resets the transmitting side of the RLC entity, and does not change or affect the operation of the receiving side of the RLC entity. In this way, the present invention prevents unnecessary discarding of data, thereby increasing transmission efficiency. Taking the user end detecting the protocol error and executing the process 30 as an example, the process 30 will only reset the uplink, and the data reception on the downlink will not be stopped. In other words, after the protocol error occurs in the uplink and the reset procedure is started, the process 30 will not affect the data transmission in the downlink, and the PDUs in the receiving buffer of the downlink will not be deleted, thereby maintaining data transmission efficiency.

In addition, when the RLC entity of the network end successfully receives the RESET PDU, the RLC entity of the network end will respond with a RESET ACK PDU and then begin transmitting PDUs. If the RESET ACK PDU is lost in the wireless transmission process, the RLC entity of the user end will retransmit another RESET PDU. In this situation, because the present invention does not change the operation of the receiving side of the RLC entity, the user end can continue receiving PDUs on the downlink, such that the PDUs outputted by the network end will not be wasted.

Thus, through the process 30, the present invention can prevent unnecessary deletion of data, thereby improving transmission efficiency and preventing waste of system resources.

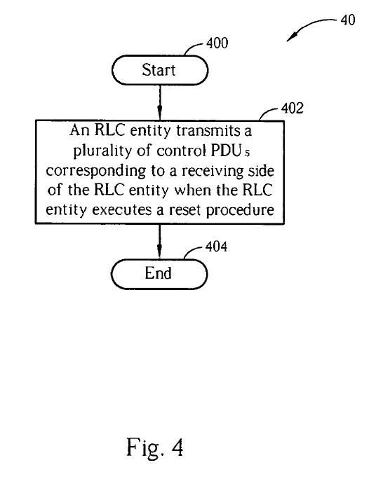

Please refer to FIG. 4. FIG. 4 is a diagram of a process 40 according to a second embodiment of the present invention. The process 40 is used in a wireless communications system for handling a protocol error by resetting a single side of an RLC layer. The process 40 can be seen as the single-side reset procedure program code 220. The process 40 comprises the following steps:

Step 400: Start.

Step 402: An RLC entity transmits a plurality of control PDUs corresponding to a receiving side of the RLC entity when the RLC entity executes a reset procedure.

Step 404: End.

According to the process 40, after the RLC entity starts the reset procedure, the RLC entity can transmit the control PDUs corresponding to the receiving side. Like the description above, the control PDUs corresponding to the receiving side comprise the ACK/NACK, Change Window Size, and MRW ACK STATUS PDU, and the RESET ACK PDU. Because the process 40 can continue to transmit the control PDUs corresponding to the receiving side after the reset procedure has started, the RLC entity can continue to determine information related to the RLC entity (itself), such as PDU reception status (positively or negatively acknowledged), whether an MRW request has been received and an MRW ACK has been responded with, and whether a RESET PDU has been received. For the user end (such as the mobile communications device), the receiving side of the RLC entity is the downlink; and for the network end (such as the networking device), the receiving side of the RLC entity is the uplink. Thus, after the user end starts the reset procedure on the uplink through the process 40, the RLC entity of the network end can continue to determine the transmission status on the downlink.

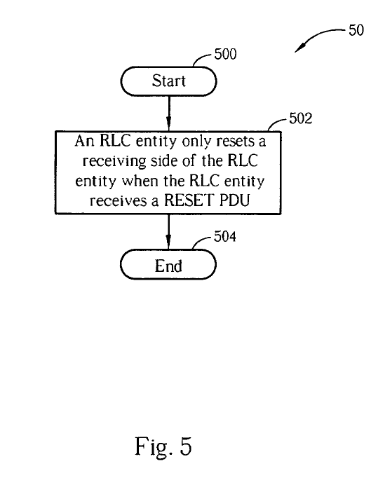

Of course, resetting the transmitting side of one end is analogous to resetting the receiving side of the other end. Please refer to FIG. 5, which is a diagram of a process 50 according to a third embodiment of the present invention. The process 50 is used in a wireless communications system for handling a protocol error by resetting a single side of an RLC layer, and can be seen as the single-side reset procedure program code 220. The process 50 comprises the following steps:

Step 500: Start.

Step 502: The RLC entity only resets the receiving side of the RLC entity when the RLC entity receives a RESET PDU.

Step 504: End.

According to the process 50, when the RLC entity receives the RESET PDU, the RLC entity only resets its receiving side. For the user end (such as the mobile communications device), the receiving end of the RLC entity is the downlink; and, for the network end (such as the networking device), the receiving side of the RLC entity is the uplink. Thus, the present invention can only reset the downlink of the user end or the uplink of the network end through the process 50. Further, when the RLC entity only resets the receiving side, the RLC entity of one end preferably can output a RESET ACK PDU to advise an RLC entity of the other end that the RLC entity of the one end has already started the reset procedure according to a request from the other end.

In conclusion, the present invention can reset a single side, i.e. an uplink or a downlink, of an RLC entity to prevent unnecessary deletion of data and waste of system resources, and improve transmission efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling protocol errors in a wireless communications system, the wireless communications system comprising a first communications apparatus and a second communications apparatus that have established a wireless connection, the method comprising:
a first Radio Link Control (RLC) entity of the first communications apparatus resetting only a transmitting side of the first RLC entity when a protocol error of the transmitting side is detected.

2. The method of claim 1 further comprising the first RLC entity transmitting a RESET Protocol Data Unit (PDU) to a second RLC entity of the second communications apparatus, wherein the RESET PDU comprises a Hyper Frame Number Indicator (HFNI) field for indicating a hyper frame number of a transmitter of the first RLC entity.

3. The method of claim 1, wherein a receiving side of the first RLC entity is not affected when the first RLC entity only resets the transmitting side of the first RLC entity.

4. The method of claim 1, wherein detection of the protocol error of the transmitting side occurs when a discard Service Data Unit (SDU) function of the first RLC entity operates in a first mode and after a number of times a PDU has been scheduled reaches a transmission upper limit.

5. The method of claim 4, wherein the first mode is a reset mode of no SDU discard after the transmission upper limit of transmissions.

6. The method of claim 1, wherein detection of the protocol error of the transmitting side occurs after a number of times a Move Receiving Widow (MRW) command of the first RLC entity has been transmitted reaches an upper limit.

7. The method of claim 1, wherein detection of the protocol error of the transmitting side occurs when the first RLC entity receives a STATUS PDU comprising an erroneous sequence number.

8. The method of claim 7, where the STATUS PDU is a piggybacked STATUS PDU.

9. The method of claim 1 further comprising the first RLC entity stopping PDU transmission.

10. The method of claim 1 further comprising the first RLC entity discarding a control PDU corresponding to the transmitting side of the first RLC entity.

11. The method of claim 10, wherein the control PDU is an MRW STATUS PDU.

12. The method of claim 1 further comprising the first RLC entity not stopping a plurality of timers corresponding to a receiving side of the first RLC entity.

13. The method of claim 12, wherein the plurality of timers corresponding to the receiving side of the RLC entity comprise a status prohibit timer and a periodic status timer.

14. The method of claim 12 further comprising the first RLC entity not stopping a reset timer, a periodic polling timer, and an SDU discard timer.

15. The method of claim 14 further comprising the first RLC entity stopping a timer corresponding to the transmitting side of the first RLC entity except the reset timer, the periodic polling timer, and the SDU discard timer.

16. The method of claim 15, wherein the first RLC entity stops a polling timer, a poll prohibit timer, and an MRW timer.

17. The method of claim 1, wherein the wireless communications system operates in Acknowledged Mode.

18. A first mobile communications device of a wireless communications system, for handling protocol errors and having a wireless connection established with a second mobile communications device, the first mobile communications device comprising:
a control circuit for realizing a function of the first mobile communications device;
a central processing unit for executing a program code to operate the control circuit; and
a memory for storing the program code;
wherein the program code comprises:
a first Radio Link Control (RLC) entity only resetting a transmitting side of the first RLC entity when a protocol error of the transmitting side is detected.

19. The mobile communications device of claim 18, wherein the program code further comprises the first RLC entity transmitting a RESET Protocol Data Unit (PDU) to a second RLC entity of the second mobile communications device, the RESET PDU comprising a Hyper Frame Number Indicator (HFNI) field for indicating a hyper frame number of a transmitter of the first RLC entity.

20. The mobile communications device of claim 18, wherein when the first RLC entity only resets the transmitting side of the first RLC entity in the program code, a receiving side of the first RLC entity is not affected.

21. The mobile communications device of claim 18, wherein detection of the protocol error of the transmitting side occurs in the program code when an Service Data Unit (SDU) discard function of the first RLC entity operates in a first mode and a number of times a PDU has been scheduled for transmission reaches a transmission upper limit.

22. The mobile communications device of claim 21, wherein the first mode is a reset mode of no SDU discard after the transmission upper limit of transmissions.

23. The mobile communications device of claim 18, wherein detection of the protocol error of the transmitting side occurs in the program code when a number of times a Move Receiving Widow (MRW) command of the first RLC entity has been transmitted equals an upper limit.

24. The mobile communications device of claim 18, wherein detection of the protocol error of the transmitting side occurs in the program code when the first RLC entity receives a STATUS PDU comprising an erroneous sequence number.

25. The mobile communications device of claim 24, wherein the STATUS PDU is a piggybacked STATUS PDU.

26. The mobile communications device of claim 18, wherein the program code further comprises the first RLC entity stopping transmission of PDUs.

27. The mobile communications device of claim 18, wherein the program code further comprises the first RLC entity deleting a control PDU corresponding to the transmitting side of the first RLC entity.

28. The mobile communications device of claim 27, wherein the control PDU is an MRW STATUS PDU.

29. The mobile communications device of claim 18, wherein the program code further comprises the first RLC entity not stopping a timer corresponding to a receiving side of the first RLC entity.

30. The mobile communications device of claim 29, wherein the timer corresponding to the receiving side of the first RLC entity comprises a status prohibit timer and a periodic status timer.

31. The mobile communications device of claim 29, wherein the program code further comprises the RLC entity not stopping a reset timer, a periodic polling timer, and an SDU discard timer.

32. The mobile communications device of claim 31, wherein the program code further comprises the first RLC entity stopping a plurality of timers corresponding to the transmitting side of the first RLC entity other than the reset timer, the periodic polling timer, and the SDU discard timer.

33. The mobile communications device of claim 32, wherein the first RLC entity stops a polling timer, a poll prohibit timer, and an MRW timer.

34. The mobile communications device of claim 18, wherein the mobile communications device operates in Acknowledged Mode.

35. A method of handling protocol errors in a wireless communications system comprising:
an Radio Link Control (RLC) entity transmitting at least one control Protocol Data Unit (PDU) corresponding to a receiving side of the RLC entity when the RLC entity executes a reset procedure.

36. The method of claim 35, wherein the at least one control PDU comprises an Acknowledged (ACK) STATUS PDU, a Negatively Acknowledged (NACK) STATUS PDU, a Change Window Size STATUS PDU, an Move Receiving Widow (MRW) ACK STATUS PDU, or a RESET ACK PDU.

37. The method of claim 35, wherein the RLC entity operates in Acknowledged Mode.

38. A mobile communications device used in a wireless communications system for handling protocol errors, the mobile communications device comprising:
a control circuit for realizing a function of the mobile communications device;
a central processing unit for executing a program code to operate the control circuit; and
a memory for storing the program code;
wherein the program code comprises:
an Radio Link Control (RLC) entity transmitting at least one control Protocol Data Unit (PDU) corresponding to a receiving side of the RLC entity when a reset procedure of the RLC entity is executed.

39. The mobile communications device of claim 38, wherein the at least one control PDU comprises an Acknowledged (ACK) STATUS PDU, a Negatively Acknowledged (NACK) STATUS PDU, a Change Window Size STATUS PDU, an Move Receiving Widow (MRW) ACK STATUS PDU, or a RESET ACK PDU.

40. The mobile communications device of claim 38, wherein the mobile communications device operates in Acknowledged Mode.

41. A method of handling a protocol error in a wireless communications system comprising:
an Radio Link Control (RLC) entity only resetting a receiving side of the RLC entity when the RLC entity receives a RESET Protocol Data Unit (PDU).

42. The method of claim 41, wherein a transmitting side of the RLC entity is not affected when the RLC entity only resets the receiving side of the RLC entity.

43. The method of claim 41 further comprising the RLC entity outputting a RESET Acknowledged (ACK) PDU.

44. The method of claim 41, wherein the mobile communications system operates in Acknowledged Mode.

45. A mobile communications device used in a wireless communications system for handling a protocol error, the mobile communications device comprising:
a control circuit for realizing a function of the mobile communications device;
a central processing unit for executing a program code to operate the control circuit; and
a memory for storing the program code;
wherein the program code comprises:
an Radio Link Control (RLC) entity only resetting a receiving side of the RLC entity when the RLC entity receives a RESET Protocol Data Unit (PDU).

46. The mobile communications device of claim 45, wherein a transmitting side of the RLC entity is not affected when the RLC entity only resets the receiving side of the RLC entity in the program code.

47. The mobile communications device of claim 45, wherein the program code further comprises the RLC entity outputting a RESET Acknowledged (ACK) PDU.

48. The mobile communications device of claim 45, wherein the mobile communications device operates in Acknowledged Mode.
